(19) United States
(12) Patent Application Publication
(10) Pub. No.: US 2005/0265154 A1
(43) Pub. Date: Dec. 1, 2005

(54) Optical disk apparatus and optical-disk image forming method

(75) Inventor: Sadanari Fujimoto, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 10/942,777

(22) Filed: Sep. 17, 2004

(30) Foreign Application Priority Data
May 27, 2004 (JP) 2004-157484

(51) Int. Cl. G11B 5/09

(52) U.S. Cl. 369/47.1; 369/53.1; 369/59.1

(57) ABSTRACT

An optical disk apparatus has a rotation section rotates an optical disk having a photoimageable layer that is made imageable by laser light, a pickup section having a laser radiation section, a driving section of the pickup section, an irradiation driving section supplies a driving current in a continuous pulse mode to drive the laser radiation section to irradiate onto the photoimageable layer, a generating section generates drive information for the pickup section and the irradiation driving section in accordance with gradation information per rotation of the optical disk, the gradation information being obtainable by receiving image information and transforming the image information, and a control section controls gradation of a visualized image in accordance with a driving current in the continuous pulse mode by controlling the driving section and the irradiation driving section.

### CROSS-REFERENCE TO RELATED APPLICATIONS

This application is based upon and claims the benefit of priority from prior Japanese Patent Application No. 2004-157484, filed May 27, 2004, the entire contents of which are incorporated herein by reference.

### BACKGROUND OF THE INVENTION

1. Field of the Invention

The present invention relates generally to optical disk apparatuses, such as DVDs (digital versatile disks) and CDs (compact disks). More particularly, the invention relates to an optical disk apparatus for forming images of labels of optical disks by using laser light generated by the optical disk apparatus, and further relates to an optical disk image forming method.

2. Description of the Related Art

In recent years, optical disks, such as DVDs, are widely used as recording media. Ordinarily, a label of the recorded contents is furnished on the surface of such a disk. Generally, such a label is separately created and adhered to the disk surface or is directly printed on the disk. However, techniques have been proposed in which a layer of a material variable in color upon irradiation of laser light is formed on a disk, and a label image is formed by using the laser light emitted from an optical disk apparatus.

By way of relevant example, Patent Reference 1 (Jpn. Pat. Appln. KOKAI Publication No. 2002-203321) discloses a technique for forming an image on a color variable layer by using the power of laser light emitted from an optical pickup, in which the tonal gradation of the image can be represented corresponding the intensity of laser light.

In addition, Patent Reference 2 (Jpn. Pat. Appln. KOKAI Publication No. 2004-5848) discloses a technique with an example in which, similar to the above, the power of laser light emitted from an optical pickup is used to form an image on a color variable layer. In this case, gradation data is prepared in units of rotation, and the image is formed corresponding the intensity of the laser light.

The above-described prior arts are described such that the laser light is repeatedly irradiated intermittently to obtain sufficient intensity of laser light that is used to form the image. However, no detailed description is provided regarding the type of the driving current that drives the laser light when continuous images are formed. Therefore, problems remain in that the type of the driving current is applied to perform the irradiation of the high-intensity laser light is unknown.

### BRIEF SUMMARY OF THE INVENTION

An embodiment according to the present invention comprises a rotation section which rotates an optical disk having a photoimageable layer that is made imageable by laser light; a pickup section having a laser radiation section which irradiates the laser light onto the photoimageable layer; a driving section which drives the pickup section; an irradiation driving section which supplies a driving current in a continuous pulse mode to drive the laser radiation section to irradiate onto the photoimageable layer; a generating section which generates drive information for the pickup section and the irradiation driving section in accordance with any one of gradation information per rotation of the optical disk, the gradation information being provided from the outside, and gradation information per rotation of the optical disk, the gradation information being obtainable by receiving image information and transforming the image information; and a control section which controls the position of the laser light by controlling the driving section in accordance with the drive information generated by the generating section and which controls gradation of a visualized image in accordance with the driving current in the continuous pulse mode by controlling the irradiation driving section, thereby controls so that the visualized image is rendered corresponding to the image information on the optical disk.

### BRIEF DESCRIPTION OF THE SEVERAL VIEWS OF THE DRAWING

FIG. 1 is a block diagram showing an example of a configuration of an optical disk apparatus according to an embodiment of the present invention;

FIG. 2 is a system view showing an example of a configuration of a disk drive section of the optical disk apparatus according to the embodiment of the invention;

FIG. 3 is a plan view showing an example of a label of an optical disk to be rendered by the optical disk apparatus according to the embodiment of the invention;

FIG. 4 is a cross-sectional view showing an example of a configuration of an optical disk having a photoimageable layer that is handled by the optical disk apparatus according to the embodiment of the invention; and

FIG. 5 is an explanatory view showing an example of rendition by a pulse train in the optical disk apparatus according to the embodiment of the invention.

### DETAILED DESCRIPTION OF THE INVENTION

An embodiment of the present invention will be described in detail below with reference to the accompanying drawings.

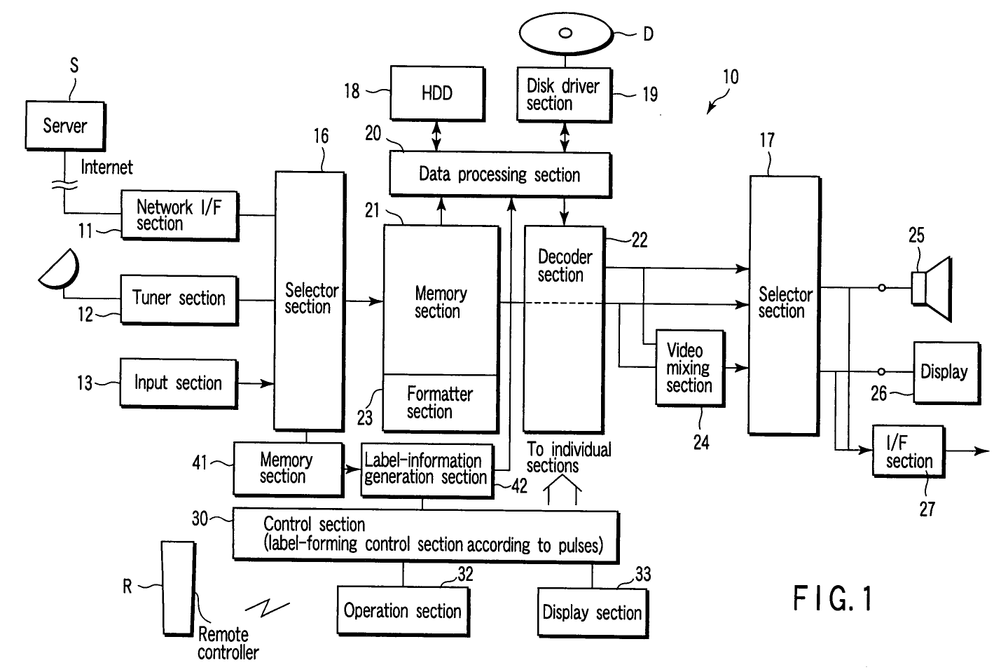

More specifically, an optical disk apparatus of the present invention will be described in detail with reference to an optical disk apparatus 10 that is a composite recording/playback apparatus as shown in FIG. 1.

<Optical Disk Apparatus According to Embodiment of the Present Invention>

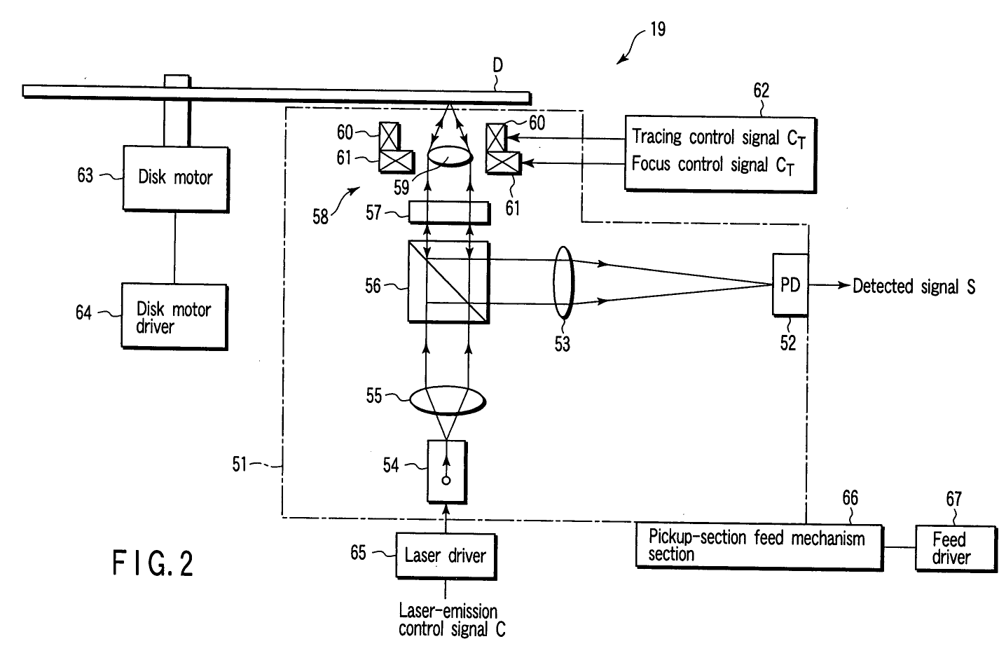

First, a configuration of the optical disk apparatus according to the present invention will be described with reference to the drawings. FIG. 1 is a block diagram showing an example of the configuration of the optical disk apparatus 10 according to the embodiment of the invention, and FIG. 2 is a system view showing an example of a configuration of a disk drive section of the optical disk apparatus 10 according to the embodiment of the invention.

(Configuration)

According to the present embodiment, the optical disk apparatus 10 is disclosed as an apparatus capable of handling both of a DVD-RAM (random access memory) and hard disk as a recording medium. However, the hard disk or DVD-RAM may be replaced with, for example, a recording medium formed of a semiconductor memory. In FIG. 1, individual blocks are broadly grouped into two: one group of major blocks of a recording section on the lefthand side, and the other group of major blocks of a reproducing section on the righthand side.

The optical disk apparatus 10 shown in FIG. 1 has two disk drive sections, namely, a disk drive section 19 and a hard disk drive (HDD) section 18. The disk drive section 19 rotationally drives an optical disk D as a first medium used as an information recording medium capable of configuring a video file, and executes read and write of information. The HDD section 18 drives a hard disk serving as a second medium. A control section 30 controls total operation and is hence connected to individual sections. For example, the control section 30 can supply record data to, for example, the disk drive section 19 and the HDD section 18, and can receive reproduced signals.

Referring to FIG. 2, the disk drive section 19 has, for example, various systems for the optical disk D, such as a rotation control system, a laser driving system, and an optical system. More specifically, as shown in FIG. 2, the disk drive section 19 has a disk motor 63 which rotates the optical disk D at a predetermined rotational velocity; a disk motor driver 64 which supplies the disk motor 63 with a driving current under the control of the control section 30 thereby to drive the disk motor 63; an optical pickup 51; a tracking control section/focus control section 62 that receives a tracking error signal and a focus error signal, supplies an actuator 58 described below with a tracking control signal C_{T} and a focus control signal C_{F}, and thereby controls tracking and focusing of an objective lens 59; a pickup-section feed mechanism section 66 which moves the optical pickup 51 along the radial direction of the optical disk D; and a feed driver 67 which supplies the driving current to the pickup-section feed mechanism section 66.

As shown in FIG. 2, the optical pickup 51 of the optical disk apparatus 10 according to the invention has the actuator 58, which has the objective lens 59. The actuator 58 has an actuator drive coil 60 in the track direction and an actuator drive coil 61 in the focus direction. In the configuration, servo control is enabled due to the individual tracking control signal C_{T} and focus control signal C_{F} being supplied from the tracking control section/focus control section 62.

The optical pickup 51 performs both light reception and radiation with the function of a beamsplitter 56. A radiation of laser light emitted from a laser diode 54 corresponding to a control signal from a laser driver 65 travels through a collimating lens 55, the beamsplitter 56, a one-quarter ( 1/4) waveplate 57, and the like, is focused by the objective lens 59, and is thus directed to irradiates a predetermined region of the optical disk D. Further, reflected light from the optical disk D is expanded by the objective lens 59, split by the beamsplitter 56 to the side of a focusing lens 53, and supplied to a photodetector 52. The photodetector 52 supplies a detected signal S. A tracking error signal and a focus error signal are supplied to the tracking control section 62 and the focus control section 62 via an RF amplifier (not shown), and the detected signal S for generating a reproduction signal is supplied to a data processing section 20.

In addition, the optical disk apparatus according to the invention has a write APC (auto power controller) circuit (not shown). The APC circuit receives a front monitor signal from a front monitor (not shown) of the optical pickup 51 and supplies the laser driver 65 with an appropriate control signal C corresponding to the front monitor signal whereby to control the laser driver 65. In particular, the APC circuit controls whether laser light is appropriately output in the event of, for example, writing to the optical disk D and label image forming to be described later.

The control section 30 processes data in units of recording or reproducing, and includes a buffer circuit, an error corrector section, and the like.

Major configuration elements of the optical disk apparatus 10, shown in FIG. 1, have an encoder section 21 constituting the video recording side, a decoder section 22 constituting the reproducing side, and the control section 30 for controlling operation of the entire apparatus. Specifically, the optical disk apparatus 10 has an input-side selector section 16 and an output-side selector section 17. The input-side selector section 16 is connected to a network I/F (interface) section 11, a tuner section 12, and an input section 13, whereby to output signals to the encoder section 21 or a memory section 41 that stores data such as image information. The optical disk apparatus 10 further has a formatter section 23 connected to the encoder section 21; and it has, as described above, the data processing section 20 for receiving an output of the encoder section 21, and the HDD section 18 and disk drive section 19 connected to the data processing section 20. The optical disk apparatus 10 has the decoder section 22 that performs decoding upon receiving signals from the HDD section 18 and the disk drive section 19. Further, the optical disk apparatus 10 has a video mixing section 24 that receive signals from the encoder section 21, the decoder section 22, the control section 30, and a display section 33. An output of the output-side selector section 17 is connected to a speaker 25 and a display section 26, or is supplied to an external device through an interface (I/F) section 27 for making communication with an external device. The optical disk apparatus 10 further has an operation section 32 that is connected to the control section 30 whereby to receive user operations or operations of a remote controller R.

The remote controller R enables substantially the same operations as the operation section 32 provided in a main body of the optical disk apparatus 10. Specifically, the remote controller R enables various operations such as record/reproduction instruction to, for example, the HDD section 18 and the disk drive section 19, edit instruction, tuner operation, and setting of reserved video recording. The optical disk apparatus 10 further has the memory section 41 which receives, for example, outputs of image signals from the selector section 16 and stores the outputs; and a label-information generating section 42 for generating, for example, label information and drive information corresponding to image signals or the like.

(Basic Operations)

First, the following will provide overviews of an optical disk reproducing process and an optical disk recording process to be performed in the optical disk apparatus configured as described above. The optical disk reproducing process is performed the following manner. Under the control of the control section 30, the optical disk D rotated at a predetermined velocity by the disk motor 63 controlled by the disk motor driver 64 is irradiated with laser light driven by the laser driver 65. Reflected light of the laser light is detected by the photodetector 52 of the optical pickup 51, and the detected signal S corresponding thereto is output. The detection signal S is supplied to an RF amplifier included in the data processing section 20. An RF signal having been output from the RF amplifier is supplied to the decoder section 22 and the control section 30. Concurrently, a focus error signal and a tracking error signal, which are used as servo-driving signals, generated in the RF amplifier included in the data processing section 20, are supplied to the focus control section 62 and the tracking control section 62, respectively. In the data processing section 20, RF signals are decoded, and decoded signals are either blended by the video mixing section 24 or are directly output to the outside via the interface section 27. The control section 30 generates a control signal for controlling the rotation of the disk motor 63, whereby controlling the rotation of the disk motor 63.

Further, in the optical disk unit configured as described, an optical disk recording process is performed in the following manner. Under the control of the control section 30, data supplied through, for example, the input section 13 and the selector section 16 is temporarily stored into the memory section 41 and is thereafter supplied to the encoder section 21 to be encoded, and encoded data is output. In accordance with the encoded output and the output of the control section 30, a driving current of the laser driver 65 is supplied to the optical pickup 51. In the optical pickup 51, laser light corresponding to the driving current is emitted from the mounted laser diode 54 and is directed to irradiate the storage area of the optical disk D rotated at a predetermined velocity by the disk motor 63. In this manner, the recording process is performed.

(Detail Operations)

—Recording Process, Etc.

The operations of the optical disk apparatus 10 configured as described above will now be described in detail hereinbelow. First, operations primarily in the recording event, including other embodiments, will be described. In the input side of the optical disk apparatus 10, the network I/F section 11 is connected to, for example, a server S through the Internet whereby to download contents information and the like. The tuner section 12 selects a channel of a broadcast signal through an antenna, demodulates the signal, and outputs a video signal and an audio signal. The input section 13 receives from the outside various signals, such as brightness signals, color difference signals, video signals for a composite image or the like, and audio signals. These signals are input under control of the selector section 16 controlled by, for example, the control section 30, and selectively supplied to the encoder section 21. Thus, the encoder section 21 receives through the selector section 16 input signals, such as an external analog video signal and an external analog audio signal from the input section 13, or analog video signal and an analog audio signal from the tuner section 12.

The encoder section 21 has video and audio A/D (analog/digital) converters, a video encoder, and an audio encoder. The A/D converters digitize, for example, an analog video signal and analog audio signal having been input from the selector section 16. Additionally, the encoder section 21 includes a sub-picture video encoder. An output of the encoder section 21 is transformed by the formatter section 23 including a buffer memory into a predetermined DVD-RAM format and supplied to the control section 30.

When a directly compressed digital video signal, digital audio signal, or the like is directly input, the encoder section 21 is capable of directly supplying the compressed digital video signal, digital audio signal, or the like to the formatter section 23. In addition, the encoder section 21 is capable of directly supplying an analog-digital (A-D) converted digital video signal, audio signal, and the like to, for example, the video mixing section 24 or the selector section 17.

In the video encoder included in the encoder section 21, a digital video signal is converted into a digital video signal compressed at a variable bitrate based on the MPEG2 or MPEG1 standard. A digital audio signal is converted into a digital audio signal at a fixed bitrate based on the MPEG or AC-3 standard, or is converted into a linear-PCM digital audio signal.

Suppose that a sub-picture video signal has been input from the input section 13, or suppose that a DVD video signal having such a data structure is broadcast and the signal is has been received by the tuner section 12. In this case, the sub-picture video signal in the DVD video signal is encoded by the sub-picture video encoder (run length encoding) into a sub-picture video bitmap.

The encoded digital video signal, digital audio signal, and sub-picture video data are packed by the formatter section 23 into a video pack, audio pack, and sub-picture video pack. Further, the packs are aggregated into a format standardized by DVD-recording standards (standards for recording into, for example, a DVD-RAM, DVD-R, and DVD-RW).

In the optical disk apparatus 10 shown in FIG. 1, the information (such as video, audio, and sub-picture video data packs) formatted by the formatter section 23 and created management information can be supplied to the HDD section 18 or the disk drive section 19 through the control section 30. Thereby, the information can be recorded into the HDD section 18 or the optical disk D. In addition, in the optical disk apparatus 10, information recorded into the HDD section 18 or the optical disk D can be recorded into the optical disk D or the hard disk through the control section 30 and the disk drive section 19.

—Edit Process, Etc.

A description will now be made in detail primarily regarding the process of editing recorded information, including another embodiment. An edit process can be performed in such a manner that video objects of multiple broadcast programs recorded in the hard disk or the optical disk D are partly deleted and connected to a different object of a broadcast program.

To facilitate the edit process, the control section 30 includes an MPU (microprocessing unit) or a CPU (central processing unit); a ROM into which control programs and the like are written; and a RAM for providing a work area necessary for program execution.

Preferably, in accordance with control programs stored in the ROM, the MPU of the control section 30 uses the RAM as a work area whereby, for example, to perform read/write address determination in the disk drive section 19, defective location detection, unrecorded area detection, video-recording information position setting, UDF recording, and AV address setting. The control section 30 additionally has a control function for a label image forming process described below.

By way of still another embodiment, the control section 30 preferably has components (not shown) such as a directory detector section and a management information control section serving for the edit event and the video-recording event. Further, the control section 30 preferably has components (not shown) such as a VGM information creating section (VGM=total video management information), a copy-related information sensing section, a copy-and-scrambling information processing section (RDI processing section), a packet header processing section, a sequence header processing section, and an aspect ratio information processing section.

In the event of the edit process or another process, the contents to be notified to a user in the MPU execution results are either displayed on the display section 31 of the optical disk apparatus or displayed as OSDs (on-screen displays) on the display section 26. The control section 30 further has the operation section 32 which feeds operation signals for operating the apparatus. The operation section 32 is preferably provided together with the remote controller R.

The control section 30 thus performs control of various components such as the disk drive section 19, the HDD section 18, the encoder section 21 and/or the decoder section 22. The control in this case can be executed with timing in accordance with time data issued from an STC (system time clock). Ordinarily, the video-recording operation and the playback operation are executed in synchronization with time clock data provided from the STC. However, other processes may be executed with timing independent of the timing provided from the STC.

—Reproducing Process, Etc.

A description will now be made in detail primarily regarding the process of reproducing recorded information, including another embodiment. The decoder section 22 has a separator, a memory, a V decoder, an SP decoder, and an A decoder. The separator separates and takes out each pack from a signal of a DVD format having a pack structure. The memory is used during the execution of, for example, pack separation and other signal processes. The V decoder decodes main video image data (video pack contents) separated by the separator. The SP decoder decodes sub-picture video data (sub-picture video pack contents) separated by the separator. The A decoder decodes audio data (audio pack contents) separated by the separator. Additionally provided is a video processor that appropriately mixes decoded sub-picture images with decoded main video images whereby to output images in which sub-pictures such as menus, highlight buttons, and subtitles are superimposed with the main video image.

An output video signal of the decoder section 22 is input to the video mixing section 24. The video mixing section 24 performs mixing of text data. The video mixing section 24 is coupled with lines for directly taking signals from the tuner section 12 and the input section 13, for example. The video mixing section 24 is connected to a frame memory (not shown) that is used as a buffer. When an output of the video mixing section 24 is supplied to the selector section 17 and is selected by the selector section 17, the output is either displayed on the display section 26 or is supplied to the external device through the I/F section 27.

An output audio signal of the decoder section 22 is converted by a digital-analog (D-A) converter (not shown) to an analog signal, and the analog signal is supplied to the speaker 25 through the I/F section 27, or is supplied to the external device through the I/F (interface) section 27. The selector section 17 is controlled by a select signal sent from the control section 30. This enables the selector section 17 to directly select a signal passed through the encoder section 21 when directly monitoring a digital signal sent from, for example, the tuner section 12 or the input section 13.

In the formatter section 23 of the encoder section 21, individual separation information (information in the event of, for example, GOP-top interruption) is periodically sent to the MPU of the control section 30 during video recording. The separation information has, for example, the number of VOBU packs, an end address of I-picture from the top of the VOBU, and the playback time of VOBU.

Concurrently, information from the aspect information processing section is sent to the MPU at the time of video-recording initiation, and the MPU creates VOB stream information (STI). The STI stores data such as resolution data and aspect data, and initializations are performed in the individual decoder sections in accordance with the STI.

The control section 30 receives data in VOBU units from the formatter section 23 of the encoder section 21, and supplies the data to the disk drive section 19 or the HDD section 18. The MPU of the control section 30 creates management information necessary for the reproduction of stored data and sends the created management information to the control section 30 upon recognition of a command for data-recording termination. Thereby, the management information is recorded into the disk. Thus, when encoding is being executed, the MPU of the control section 30 receives information (such as the separation information) in units of data from the encoder section 21. In addition, at the time of recording initiation, the MPU of the control section 30 recognizes the management information (file system) having been read from the optical-disk and the hard disk, recognizes an unrecorded area of the each individual disk, and sets the recording area to the disks through the control section 30.

In addition, as described below, the control section 30 is capable of accessing, for example, a server of -contents information provided on the Internet, downloading the contents information, and recording the contents information into a storage area of the HDD section 18. In response to user operations, the contents information recorded into the storage area of the HDD section 18 is read from the HDD section 18, and is decoded by the decoder section 22. The contents information is then appropriately selected by the selector section 17 through the video mixing section 24, and is then supplied to the external device through speaker 25 and the display section 26 or through the I/F section 27.

As described above, the optical disk apparatus 10 of the present embodiment is of the type having a comprehensive functionality that performs the recording/reproducing processes with the optical disk D (or hard disk) for many sources. The label image forming process for the optical disk D in the optical disk apparatus 10 will now be described below.

<Optical-Disk Label Image Forming Process>

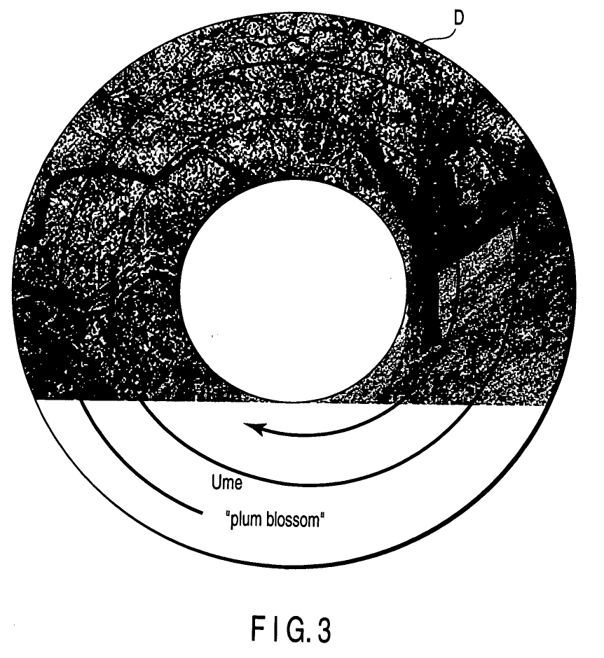

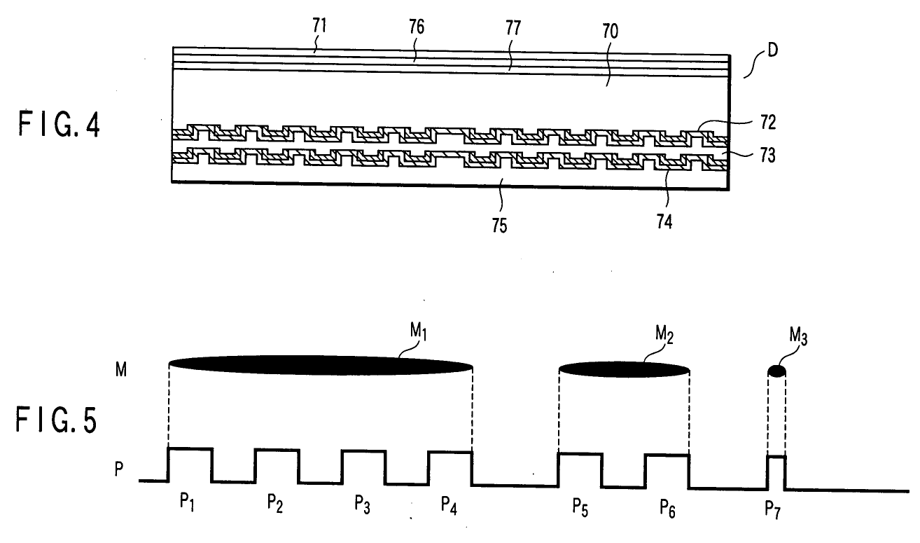

The optical disk apparatus 10 of the one embodiment according to of the present invention performs not only the recording/reproducing processes described above, but also the optical disk label image forming process using the laser light emitted from the laser diode 54. The optical disk label image forming process of one embodiment according to the present invention will be described in detail hereinbelow with reference to the drawings. FIG. 3 is a plan view showing an example of a label of an optical disk to be rendered by the optical disk apparatus according to the embodiment of the invention. FIG. 4 is a cross-sectional view showing an example of a configuration of an optical disk having a photoimageable layer that is handled by the optical disk apparatus according to the embodiment of the invention. FIG. 5 is an explanatory view showing an example of rendition by a pulse train in the optical disk apparatus according to the embodiment of the invention.

The label image may be of the type to be supplied to the input section 13 from an external device, such as a personal computer. Alternatively, the label image may be of the type obtained in such a manner that video image information of a broadcast signal selected and demodulated by, for example, the tuner section 12 is stored into, for example, the HDD section 18, and a static image obtained therefrom is processed.

First, as shown in FIG. 4, the optical disk D, such as a DVD, should have a photoimageable layer 76, which is made imageable by the laser light, to form the label image as shown in FIG. 3. The optical disk D is of a one-side two-layer type having the photoimageable layer 7.6. More specifically, as shown in FIG. 3, the optical disk D has a reflecting layer 77, the photoimageable layer 76, and a transparent protective film layer 71 on a transparent-resin substrate 70. In addition, the optical disk D has a first recording layer 72, an intermediate layer 73, a second recording layer 74, and a transparent protective layer 75.

The optical disk apparatus 10 performs label image forming in a manner described hereafter for the optical disk D having the photoimageable layer 76 described above. The label image as shown in FIG. 3 may be of the type to be supplied to the input section 13 from an external device, such as a personal computer. Alternatively, the label image may be of the type obtained in such a manner that video image information of a broadcast signal selected and demodulated by, for example, the tuner section 12 is stored into, for example, the HDD section 18, and a static image obtained therefrom is processed.

First, the case where the image information is provided from, for example, an external personal computer to the input section 13 will be described hereafter. In particular, a description will be provided with reference to a case where information of an ordinary image format, such as a JPEG or MPEG image information, is provided. Under the control of the control section 30, the image information supplied from the input section 13 is retrieved from the selector section 16 and stored into the memory section 41. The image information is then supplied to the label-information generating section 42 in accordance with the user's operation through the operation section 32 and operation of the control section. In the label-information generating section 42, when the image information for the label image represents an ordinary rectangular image, a masking process is applied to the label image information, as shown in FIG. 3, and the image information is transformed into per-rotation image information. More specifically, ordinary image information is configured as individual gradation information in terms of x-coordinate and y-coordinate. However, to form the image information in the form of a spiral or concentric circle on the photoimageable layer of the rotating optical disk, the image information is transformed into a form identifying that “gradation information is at what angle and at what rotation on the disk.” The transformation process is preferably performed using a preliminarily created transformation table to transform the ordinary image information into the form of “multiple items of gradation information at each angle per rotation on the disk.”

In accordance with the individual gradation information per rotation of the optical disk, the label-information generating section 42 generates control signals corresponding to the image information in the form of the individual per-rotation gradation information under the control of the control section 30. The control signals are a control signal for the feed driver 67 which supplies the driving current to the pickup-section feed mechanism section 66 of the optical pickup 51; a control signal for the disk motor driver 64 which supplies the driving current to the disk motor 63; and a laser-emission control signal C to be supplied to the laser driver 65 which supplies the driving current to the laser diode 54. Due to these control signals being supplied to individual sections, the individual sections are controlled under the control of the control section 30. Referring now to FIG. 5, the driving current from the laser driver 65, even when a formed image M is an image M₁ formed as a continuous photoimageable region, the driving current from the laser driver 65, namely a driving current P, does not takes the mode of a DC driving current, but takes the mode of pulse signals P₁ to P₄. This enables the power of laser light to be maximized and enables secure label image forming. In addition, in the case shown in FIG. 5, pulse signals P₅ and P₆ or a pulsewidth-modulated pulse signal P₇ are appropriately used corresponding to a label image to be rendered.

More specifically, if the driving current of the laser diode is supplied to the laser diode 54 in the singular pulse or the continuous DC mode, the maximum emission power is as low as about ½ in value of the power in the case where the driving current of the laser diode 54 in the form of a continuous pulse signal is output. For this reason, the driving current of the laser diode is not supplied in the singular pulse or continuous DC mode, but is supplied in the form of a pulse train, which is a continuous pulse signal. Thereby, a high emission power is maintained whereby to perform secure disk label image forming process.

Due to the above-described laser light emission being applied, the photoimageable layer 76 of the optical disk D is changed from the transparent state to an opaque state corresponding the light quantity or heat of the laser light. Thereby, as shown in FIG. 3, the label image having gradations according to the intensity of the laser light is formed into a spiral or concentrically circular state.

It is preferred that multiple shots of laser-light irradiation are applied in units of the rotation to even more securely perform image forming of the photoimageable layer 76. More specifically, not only that concentration gradients are represented at a single shot of irradiation by changing the intensity of the laser light, but also that the number of shots of irradiation to the same region be increased to, for example, two, five, and ten in accordance with the concentration of the gradation image whereby to enhance securability of the concentration representation.

The optical disk apparatus uses the laser diode for a laser radiation section for laser light used for the information recording process and reproducing process. Thereby, a dedicated optical disk label printer section need not be provided, and configurations of, for example, the disk rotation section, pickup section, and pickup driving section and control section can be sharedly used.

### —Other Embodiments

In addition to the above, it is preferred that image information in the form of individual per-rotation gradation information is directly received from the outside and used through the input section 13 and the like. In this case, the above-described process of transforming image information is performed in, for example, a PC (personal computer), which is an external device connected to the input section 13. Thereby, image information in the form of per-rotation gradation information corresponding to the image information is retrieved and supplied to the input section 13. In this case, the above-described transformation process need not be performed in the label-information generating section 42. In accordance with the supplied individual gradation information per rotation of the optical disk D, control signals corresponding thereto are generated. The control signals are a control signal for the feed driver 67 which supplies the driving current to the pickup-section feed mechanism section 66 of the optical pickup 51; a control signal for the disk motor driver 64 which supplies the driving current to the disk motor 63; and a laser-emission control signal C to be supplied to the laser driver 65 which supplies the driving current to the laser diode 54. By using these control signals, a label image is generated as in the manner described above.

Another preferred method is described hereunder. Data such as the image information and the image information in the form of the individual gradation information per-rotation of the optical disk D is not received from the outside. However, for example, a video signal of a broadcast signal selected and demodulated in the tuner section 12 is once stored in, for example, the memory section 41 or the HDD section 18. Then, under the control of the control section 30, the stored information is read out in response to user operations performed through the operation section 32, and the image information displayed on the display section 26 is edited as operation information mixed in the video mixing section 24. In this case, the user can arbitrarily select a static image in the video image information from the broadcast signal and arbitrarily select a region that is used as a label image. In this case, the region becomes doughnut-shaped image region partly cutaway on the optical disk D, and the image information is transformed into the image information in the form of the individual gradation information per-rotation of the optical disk D to be used in the label image forming process. Of course, the video image source is not limited only to that selected through the tuner section 12, but it may be image information sent from the server S via the Internet thorough the network I/F section 11. Alternatively, it may preferably be a user's own image supplied from, for example, digital camera through the input section.

Thus, an arbitrary image can be freely formed as a label image of the optical disk D. As such, for example, an originality-rich DVD library can easily be created using title images of broadcast programs the user successively enjoy viewing/listening and/or photographs of user's own face.

The optical disk apparatus uses the laser diode which is the laser radiation section for laser light used for the information recording process and reproducing process. Thereby, a dedicated optical disk label printer section need not be provided, and configurations of, for example, the disk rotation section, pickup section, and pickup driving section and control section can be sharedly used. In addition, in the case where the image is formed using the laser diode for the laser light, even when images to be formed are successive images, the power of laser light can be maximized by constantly setting the driving current of the to-be-used diode. That is, if the driving current of the laser diode is supplied to the pickup section in a singular pulse or a continuous DC mode, the maximum emission power is as low as about ½ in value of the power in the case where the driving current of the laser diode in the form of a continuous pulse is output. For this reason, the driving current of the laser diode is not supplied in the singular pulse or continuous DC mode, but is supplied in the form of the pulse train, which is the continuous pulse signal. Thereby, a high emission power is maintained whereby to perform secure disk label image forming process.

In the above embodiment, while description has been made regarding the one embodiment of the present invention with reference to the optical disk apparatus functioning as the composite machine including the hard disk recorder and the like, the present invention is not limited thereto. It is a matter of course that for example, equivalent processes can be implemented even with an optical disk recording/reproducing apparatus handling only an optical disk.

According to the various embodiments described above, those concerned in the art will be able to implement the invention, and various other modified examples will easily occur to those skilled in the art. Further, it will be possible even for those not having sufficient inventive knowledges and skills to adapt the invention by way of various other embodiments. The invention covers a broad range of applications as long as the applications do not contradict the principles and novel features disclosed herein, and the invention is not limited to the above-described embodiments.

1. An optical disk apparatus comprising:
a rotation section which rotates an optical disk having a photoimageable layer that is made imageable by laser light;
a pickup section having a laser radiation section which irradiates the laser light onto the photoimageable layer;
a driving section which drives the pickup section;
an irradiation driving section which supplies a driving current in a continuous pulse mode to drive the laser radiation section to irradiate onto the photoimageable layer;
a generating section which generates drive information for the pickup section and the irradiation driving section in accordance with any one of gradation information per rotation of the optical disk, the gradation information being provided from the outside, and gradation information per rotation of the optical disk, the gradation information being obtainable by receiving image information and transforming the image information; and
a control section which controls the position of the laser light by controlling the driving section in accordance with the drive information generated by the generating section and which controls gradation of a visualized image in accordance with the driving current in the continuous pulse mode by controlling the irradiation driving section, thereby controls so that the visualized image corresponding to the image information is rendered on the optical disk.

2. An optical disk apparatus according to claim 1, wherein the control section controls the rotation section, the driving section, the laser radiation section, a driving section, and the like to cause the photoimageable layer on the optical disk to be irradiated two or more times with the laser light.

3. An optical disk apparatus according to claim 1, wherein the generating section generates the drive information from image information stored in a storage area, in accordance with image information which is a specific region specified by a user operation.

4. An optical disk apparatus according to claim 1, further comprising:
a recording section which records a video signal in a manner that the laser light is irradiated by the laser radiation section onto a recording layer of the optical disk from a side opposite the photoimageable layer in accordance with control information obtained by encoding the supplied video signal; and
a reproducing section which detects a reflected light of the laser light irradiated onto the recording layer of the optical disk from the laser radiation section and which reproduces the recorded video signal in accordance with the reflected light.

5. An optical disk image forming method comprising:
using an optical disk apparatus comprising a rotation section which rotates an optical disk having a photoimageable layer that is made imageable by laser light, a pickup section having a laser radiation section which irradiates the laser light onto the photoimageable layer, a driving section which drives the pickup section, and an irradiation driving section that supplies a driving current in a continuous pulse mode to drive the laser radiation section to irradiate onto the photoimageable layer;
generating drive information for the pickup section and the irradiation driving section in accordance with any one of gradation information per rotation of the optical disk, the gradation information being provided from the outside, and gradation information per rotation of the optical disk, the gradation information being obtainable by receiving image information and transforming the image information; and
controlling the position of the laser light by controlling the driving section in accordance with the generated drive information to control gradation of a visualized image in accordance with the driving current in the continuous pulse mode by controlling the irradiation driving section, whereby to perform control such that the visualized image corresponding to the image information is rendered on the optical disk.

6. An optical disk image forming method according to claim 5, wherein the rotation section, the driving section, the laser radiation section, a driving section, and the like are controlled to cause the photoimageable layer on the optical disk to be irradiated two or more times with the laser light.

7. An optical disk image forming method according to claim 5, wherein the drive information is generated from image information stored in a storage area, in accordance with image information which is a specific region specified by a user operation.

8. An optical disk image forming method according to claim 5, further comprising:
recording a video signal in a manner that the laser light is irradiated onto a recording layer of the optical disk from a side opposite the photoimageable layer in accordance with control information obtained by encoding the supplied video signal; and
detecting a reflected light of the laser light irradiated onto the recording layer of the optical disk, whereby reproducing the recorded video signal in accordance with the reflected light.
